(19) United States
(12) Patent Application Publication
(10) Pub. No.: US 2016/0284467 A1
(43) Pub. Date: Sep. 29, 2016

(54) METHOD OF MANUFACTURING MULTILAYER FERRITE BEAD

(71) Applicant: SAMSUNG ELECTRO-MECHANICS CO., LTD., Suwon-Si (KR)

(72) Inventors: Jin Seong KIM, Suwon-Si (KR); Young Jin HA, Suwon-Si (KR); Sung Jin PARK, Suwon-Si (KR); Hyun Ju JUNG, Suwon-Si (KR)

(21) Appl. No.: 15/061,615

(22) Filed: Mar. 4, 2016

(30) Foreign Application Priority Data
Mar. 26, 2015 (KR) 10-2015-0042526

(51) Int. Cl. H01F 41/02; H01F 27/29; H01F 27/28; H01F 41/10; H01F 27/245

(52) U.S. Cl. CPC H01F 41/0233; H01F 41/10; H01F 27/245; H01F 27/2804; H01F 27/292; H01F 2027/2809

(57) ABSTRACT

A method of manufacturing a multilayer ferrite bead includes steps of: preparing ferrite sheets having internal electrodes formed on surfaces thereof; forming a ferrite laminate by stacking the ferrite sheets; forming a groove by pressurizing a central portion of the ferrite laminate; and forming external electrodes on the ferrite laminate.

### CROSS-REFERENCE TO RELATED APPLICATION

This application claims the benefit of priority to Korean Patent Application No. 10-2015-0042526, filed on Mar. 26, 2015 with the Korean Intellectual Property Office, the entirety of which is incorporated herein by reference.

### BACKGROUND

The present disclosure relates to a method of manufacturing a multilayer ferrite bead, and more particularly, to a method of manufacturing a multilayer ferrite bead in which inner coil stress is dispersed.

An inductor used in an electronic component has been variously utilized to implement filtering, impedance matching, and the like.

In accordance with miniaturization and high functionalization of electronic components, an inductor needs to be slim and light, and accordingly, research into a slim multilayer inductor has been ongoing.

A multilayer inductor is formed by forming coil patterns on ferrite sheets using a metal paste and stacking a plurality of ferrite sheets.

Generally, in a multilayer inductor, permeability of ferrite changes depending on frequency, and ferrite loss is increased at a high frequency of 100 MHz or higher.

However, a ferrite bead is operated as a device which absorbs high-frequency noise by using a reverse magnetic damping effect. That is, since the ferrite bead mainly functions as an inductor at a low-frequency region, and has high impedance proportional to the frequency at a high-frequency region, the ferrite bead may serve as an EMI filter reflecting or absorbing high frequency noise to remove the noise in the form of heat.

A multilayer ferrite bead is manufactured by pressurizing/heating a laminate in which ferrite sheets having coil patterns printed thereon are stacked, and thus internal stress is concentrated on the coil patterns during the pressurizing process, and accordingly, electrical properties of the ferrite bead may be deteriorated.

### SUMMARY

An aspect of the present disclosure may provide a method of manufacturing a multilayer ferrite bead including forming a groove by pressurizing a central portion of a ferrite laminate, in which ferrite sheets are stacked.

According to an aspect of the present disclosure, a method of manufacturing a multilayer ferrite bead comprises steps of: preparing ferrite sheets having internal electrodes formed on surfaces thereof; forming a ferrite laminate by stacking the ferrite sheets; forming a groove by pressurizing a central portion of the ferrite laminate; and forming external electrodes on the ferrite laminate.

The groove may have a depth corresponding to 1% to 10% of a thickness of the ferrite laminate.

The internal electrodes may be connected to each other through a via to form a coil.

The internal electrodes may be electrically connected to the external electrodes.

The external electrodes may be formed by a dipping process or a wheel process.

The method may further comprise a step of cutting and sintering the ferrite laminate, after the forming of the groove by pressurizing the central portion of the ferrite laminate.

According to another aspect of the present disclosure, a multilayer ferrite bead comprises a ferrite laminate comprising a plurality of ferrite sheets having internal electrodes formed on surfaces thereof; and external electrodes on the ferrite laminate, wherein the ferrite laminate includes a groove disposed in a central portion of the ferrite laminate.

### BRIEF DESCRIPTION OF DRAWINGS

The above and other aspects, features and advantages of the present disclosure will be more clearly understood from the following detailed description taken in conjunction with the accompanying drawings, in which:

FIGS. 1A through 1E are cross-sectional views illustrating a method of manufacturing a multilayer ferrite bead according to an exemplary embodiment in the present disclosure;

FIG. 1A illustrates formation of internal electrodes on ferrite sheets;

FIG. 1B illustrates formation of a ferrite laminate by stacking a plurality of ferrite sheets;

FIG. 1C illustrates pressurization of a central portion of the ferrite laminate;

FIG. 1D illustrates sintering of the ferrite laminate;

FIG. 1E illustrates formation of external electrodes on side surfaces of the ferrite laminate;

FIG. 2 is a scanning electron microscope (SEM) image of a cross section of a multilayer ferrite bead manufactured according to an exemplary embodiment in the present disclosure;

FIGS. 3A and 3B illustrate a comparison of impedances in regard to whether or not the central portion of a multilayer ferrite bead is provided with a groove;

FIG. 3A is a graph illustrating characteristics of a multilayer ferrite bead which is not provided with a groove; and

FIG. 3B is a graph illustrating characteristics of a multilayer ferrite bead which is provided with a groove having a depth corresponding to 3% of a thickness of a ferrite laminate.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

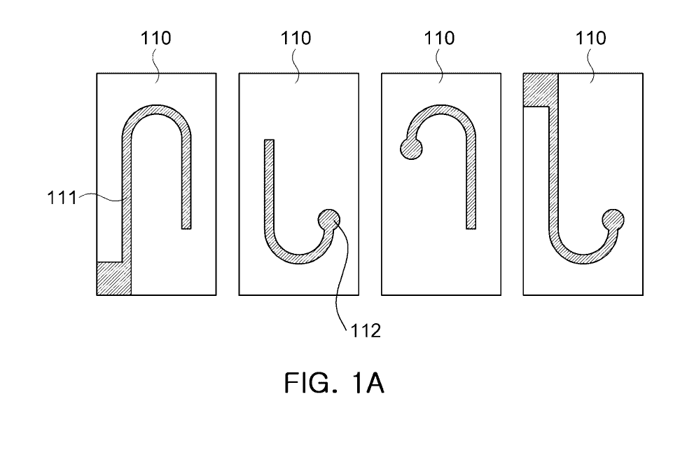

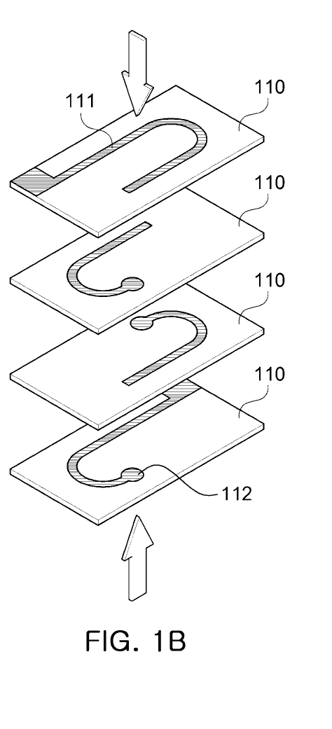

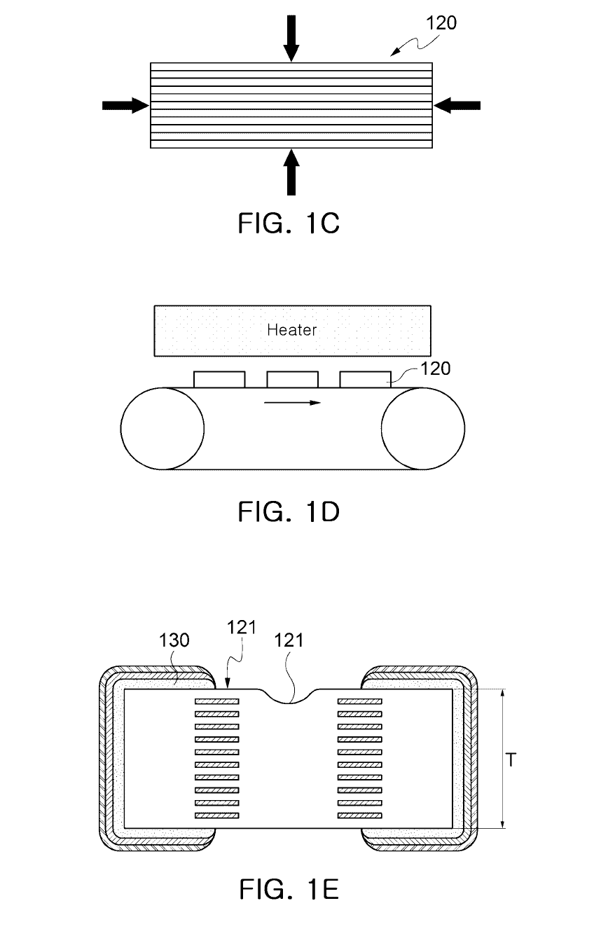

FIG. 1 is a cross-sectional view illustrating a method of manufacturing a multilayer ferrite bead according to an exemplary embodiment.

FIG. 1A illustrates formation of internal electrodes on ferrite sheets. FIG. 1B illustrates formation of a ferrite laminate by stacking a plurality of ferrite sheets. FIG. 1C illustrates pressurization of a central portion of the ferrite laminate. FIG. 1D illustrates sintering of the ferrite laminate. FIG. 1E illustrates formation of external electrodes on side surfaces of the ferrite laminate.

As shown in the drawings, a method of manufacturing a multilayer ferrite bead according to the exemplary embodiment includes preparing ferrite sheets 110 having internal electrodes 111 formed thereon; forming a ferrite laminate 120 by stacking the ferrite sheets 110; forming a groove 121 by pressurizing a central portion of the ferrite laminate; and forming external electrodes 130 on side surfaces of the ferrite laminate.

The ferrite sheet 110 may be formed of a ceramic slurry by mixing a powder containing a magnetic raw material, a solvent, an organic binder, and the like, by wet-blending and dry-blending.

A polymer resin dispersing the ferrite powder may be at least one selected from the group consisting of an epoxy resin, a polyimide resin, a polyamide resin and a polyaniline resin, These examples are merely described by way of example, and various known materials performing the same function may be employed.

The ferrite sheet 110 may be molded in a sheet form by coating the ceramic slurry on a film such as PET, or the like, to have a thickness of several tens of μm. Here, the magnetic raw materials may be an Ni-Cu-Zn-based magnetic ferrite or a Zn-Cu-based non-magnetic ferrite, but may also be various known ferrites exhibiting similar functions.

Next, pattern layers for forming internal electrodes may be formed at a predetermined position on the ferrite sheets 110. The pattern layers may be formed by thick film printing, screen printing, deposition, sputtering, and the like, and may be electrically connected to each other through a via to be described below to thereby form the internal electrodes.

In order to electrically connect the internal electrodes formed above and below the ferrite sheet, the ferrite sheet 110 may have a via hole formed at a predetermined position thereof. The via hole may be physically formed by a laser method or CNC drilling, and may become a via 112 by filling the via hole with a conductive paste.

Since the conductive paste is electrically connected to the internal electrodes, the conductive paste may be formed of the same materials as the internal electrodes in order to prevent transmission of electrical signals and bonding ability deterioration.

The internal electrodes 111 and the via 112 may be co-sintered with the ferrite sheets 110, and the co-sintering process may be performed by using silver (Ag) having low resistance.

The internal electrodes 111 may form coils on a single ferrite sheet, wherein the coils have ring-shaped patterns wound with a length of at least one turn.

The plurality of ferrite sheets may be stacked to form the ferrite laminate 120. In the ferrite laminate 120, the plurality of ferrite sheets 110 having the internal electrodes 111 formed thereon may be sequentially stacked to form required turns. Accordingly, the ferrite laminate 120 may be easily designed to have impedance in a required or appropriate range which is appropriate for removing noise in order to be used in a bead.

A process of pressurizing the ferrite laminate 120 may be included. The ferrite laminate 120 is formed by stacking the plurality of ferrite sheets 110, and accordingly, adhesive strength between respective ferrite sheets 110 is weak, and thus the ferrite laminate is required to be pressurized and fixed. In addition, the ferrite laminate 120 may be more firmly fixed in a sintering process to be described below.

In the process of pressurizing the ferrite laminate 120, the central portion of the ferrite laminate 120 may be pressurized to form the groove 121.

The pressurizing process may be performed by using a pressing jig including an upper press and a lower press. The upper press and the lower press may be individually controlled to pressurize only an upper part or a lower part of the ferrite laminate or pressurize an upper part and a lower part of the ferrite laminate at the same time.

The upper press and the lower press may be formed with protrusions in a central portion, and thus the groove 121 may be formed in the central portion of the ferrite laminate while pressurizing the upper and lower parts of the ferrite laminate.

The groove 121 may disperse compressive stress concentrated on the internal electrodes 111 in the process of stacking and pressurizing the ferrite laminate 120. That is, since the stress is concentrated on the internal electrodes 111 as the ferrite sheets 110 having the internal electrodes formed thereon are stacked, only the central portion of the ferrite laminate 120 between the internal electrodes may be selectively pressurized to disperse residual stress of the internal electrodes.

The groove 121 is required to be formed in order not to destroy physical properties of the multilayer ferrite bead.

The groove may have a depth D corresponding to 1.0-10.0% of a thickness T of the ferrite laminate.

When the depth D of the groove corresponds to less than 1.0% of the thickness T of the ferrite laminate, efficiency of dispersing stress concentrated on the internal electrodes 111 may be significantly deteriorated. When the depth D of the groove corresponds to more than 10.0% of the thickness T of the ferrite laminate, interlayer cracking of the ferrite sheets may occur in the pressurization process for forming the groove, which may cause short circuiting of the internal electrodes, and may be classified as a defect upon visual inspection.

When the groove is formed to have a preset depth in the ferrite laminate, the upper press moves upwardly and the lower press moves downwardly so as to be separated from the ferrite laminate.

In the process of forming the groove in the central portion of the ferrite laminate by using the pressing jig, the depth D of the groove is required to be controlled by setting a predetermined pressure and time conditions in consideration of thickness T of the ferrite laminate. In the process of pressurizing the ferrite laminate 120, the depth of the groove is required to be selected by predicting a variable range thereof in consideration of the degree of contraction of the ferrite laminate in the following process of sintering the ferrite laminate.

A process of sintering the ferrite laminate 120 may be included. The sintering process may be performed by using a heater. When the internal electrodes of the multilayer ferrite bead are formed of silver (Ag), the silver (Ag) has a melting point of 961° C., and thus a lower temperature than the melting point of the silver (Ag) may be required to prevent the internal electrodes from being deformed.

Then, a process of cutting the ferrite laminate 120 may be performed to form a unit multilayer ferrite bead. First ends of the internal electrodes may be exposed to one surface of the ferrite laminate, and second ends of the internal electrodes may be exposed to the opposite surface thereof. The exposed internal electrodes may be electrically connected to the external electrodes.

Next, a process of forming the external electrodes 130 on side surfaces of the ferrite laminate 120 may be performed. The external electrodes 130 may be mounted on pads disposed on a board to thereby provide electrical connection.

The external electrodes 130 may be formed by using metal materials on left and right side surfaces of the laminate by a dipping process or a wheel process, and may also be formed by other known methods.

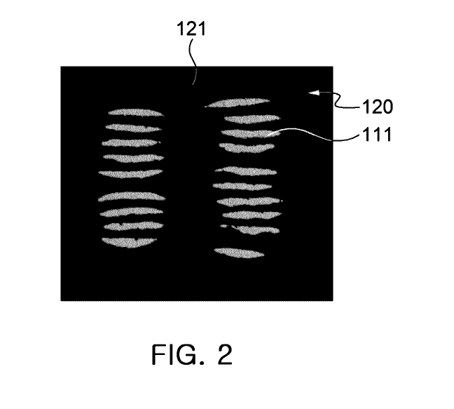

FIG. 2 is a scanning electron microscope (SEM) image of a cross section of the multilayer ferrite bead according to an exemplary embodiment.

As shown in FIG. 2, the multilayer ferrite bead may be provided with the groove 121 at a central portion thereof. The groove 121 may be formed by pressurizing the central portion of the ferrite laminate 120, and may have the depth D corresponding to 3% of the thickness T of the ferrite laminate.

When the depth D of the groove corresponds to less than 1% of the thickness T of the ferrite laminate, stress of the internal electrodes may not be sufficiently dispersed, and when the depth D of the groove corresponds to 10% or more of the thickness T of the ferrite laminate, stress of the internal electrodes may be sufficiently dispersed, but short circuits may occur between the internal electrodes due to cracking between the sheets when a multilayer ferrite bead structure is deformed or the ferrite laminate is pressurized.

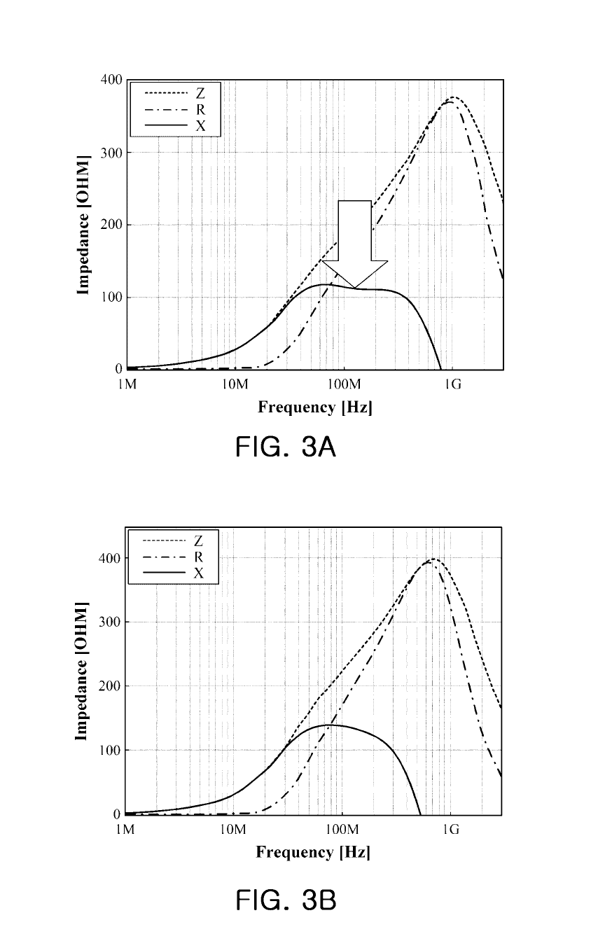

FIG. 3 is a comparison of impedances in regard to whether or not the central portion of a multilayer ferrite bead is provided with a groove; FIG. 3A is a graph illustrating characteristics of a multilayer ferrite bead which is not provided with a groove; and FIG. 3B is a graph illustrating characteristics of the multilayer ferrite bead which is provided with a groove having a depth corresponding to 3% of a thickness of a ferrite laminate.

A multilayer ferrite bead without the groove has a depression region at a central region (about 100 MHz) of a reactance graph (X), which indicates that stress is still concentrated on the internal electrodes.

In addition, a multilayer ferrite bead with the groove provided may have higher impedance. As an example, it could be confirmed that an impedance Z of the multilayer ferrite bead provided with a groove of 3% thickness at 100 MHz was 160.5Ω, and the impedance Z of the multilayer ferrite bead without the groove was 133.0Ω, and thus the multilayer ferrite bead with the groove had impedance increased by 20.7% as compared to that of the multilayer ferrite bead without the groove.

According to the exemplary embodiment, high frequency impedance may be improved as compared to a product having the same size, and thus, high frequency noise may be further blocked.

As set forth above, the method of manufacturing a multilayer ferrite bead according to exemplary embodiments may disperse compressive stress concentrated on the internal electrodes of the ferrite laminate to thereby manufacture a laminate ferrite bead having improved electrical properties.

While exemplary embodiments have been shown and described above, it will be apparent to those skilled in the art that modifications and variations could be made without departing from the scope of the present disclosure as defined by the appended claims.

What is claimed is:

1. A method of manufacturing a multilayer ferrite bead, the method comprising steps of:
preparing ferrite sheets having internal electrodes formed on surfaces thereof;
forming a ferrite laminate by stacking the ferrite sheets;
forming a groove by pressurizing a central portion of the ferrite laminate; and
forming external electrodes on the ferrite laminate.

2. The method of claim 1, wherein the groove has a depth corresponding to 1% to 10% of a thickness of the ferrite laminate.

3. The method of claim 1, wherein the internal electrodes are connected to each other through a via to form a coil.

4. The method of claim 3, wherein the internal electrodes are electrically connected to the external electrodes.

5. The method of claim 1, wherein the external electrodes are formed by a dipping process or a wheel process.

6. The method of claim 1, further comprising a step of cutting and sintering the ferrite laminate, after the forming of the groove by pressurizing the central portion of the ferrite laminate.

7. A multilayer ferrite bead comprising:
a ferrite laminate comprising a plurality of ferrite sheets having internal electrodes formed on surfaces thereof; and
external electrodes on the ferrite laminate,
wherein the ferrite laminate includes a groove disposed in a central portion of the ferrite laminate.

8. The multilayer ferrite bead of claim 7, wherein the groove has a depth corresponding to 1% to 10% of a thickness of the ferrite laminate.
